(19) United States
(12) Patent Application Publication
(10) Pub. No.: US 2026/0254396 A1
(43) Pub. Date: Aug. 27, 2026

(54) ENERGY SUPPLY SYSTEM FOR COUPLING TO A WIND TURBINE USED IN ISLAND MODE, AND METHOD FOR SUPPLYING THE WIND TURBINE WITH SOLAR ENERGY

(71) Applicant: Siemens Energy Global GmbH & Co. KG, München (DE)

(72) Inventors: Ralf Krause, Herzogenaurach (DE); Yashar Musayev, Nürnberg (DE); Helmut Eckert, Röttenbach (DE); Andreas Bartmann, Erlangen (DE)

(21) Appl. No.: 19/163,049

(22) PCT Filed: Jun. 17, 2024
(86) PCT No.: PCT/EP2024/066718

§ 371 Date: Sep. 8, 2025

(30) Foreign Application Priority Data
Jul. 4, 2023 (DE) 10 2023 206 321.2

(51) Int. Cl. H02S 10/12; H02J 1/10; H02J 15/50; H02J 101/40; H02S 10/20; H02S 40/44

(52) U.S. Cl. CPC H02S 10/12; H02J 1/10; H02J 15/50; H02S 10/20; H02S 40/44; H02J 2101/40

(57) ABSTRACT

An energy supply system is specified for coupling to a wind power station that is used in island mode and that operates an electrolysis facility for the production of green hydrogen with wind energy. The novel energy supply system has a solar energy source, with a photovoltaic module and/or a solar thermal collector, which is configured to supply the electrolysis facility, in particular a containment and water-carrying lines of electrolysis units of the electrolysis facility, with thermal energy in the event of the absence of wind energy. There is also described a corresponding method for coupling solar energy to a wind power station that is operated in island mode.

The present invention relates to an energy supply system for coupling to a wind power station used in island mode, i.e. without grid coupling, wherein the wind turbine supplies wind energy in particular to an electrolysis facility for producing green hydrogen. Furthermore, a corresponding method for supplying the wind power station with solar energy is specified.

Going forward, there is an urgent need to use renewable energy sources, such as wind and solar, on a priority basis, in order to reduce (global) CO₂ emissions. In addition to direct utilization as electrical power, the renewable electricity shall also be able to serve as a raw material for production of basic chemical materials or fuels, such as hydrogen.

These combinations of wind power station (wind turbine) and electrolyzer can also be operated without grid coupling. The electrolysis units are ideally placed close to the renewable energy sources in order to reduce or avoid transformation losses and/or line losses. For example, electrolysis facilities are being developed which are mounted directly on a platform on an offshore wind power station. With such coupling, whether “onshore” or “offshore”, this facility can also be operated without connection to the power grid. Without the grid coupling, however, electricity is available neither through the wind generator nor through the power grid during a calm or lull in the wind. PEM electrolysis, as it is known (PEM for “polymer electrolyte membrane” or “proton exchange membrane”), is increasingly gaining potential as an energy carrier, e.g. for industrial applications or as a storage medium, owing to its great potential for producing low-cost green hydrogen. In the course of climate change, the element hydrogen (H₂) and/or the possibility of producing H₂ from renewable energy via PEM or water electrolysis has long proven to be a key factor for the energy industry and adjacent sectors.

Although most of the hydrogen is still produced today by steam reforming of methane, aggressive investment and assistance measures are likely to bring about a trend toward regenerative hydrogen production.

A particularly promising process for obtaining hydrogen (H₂) is the electrolysis of water, especially using renewable electrical energy. One of the possible uses of hydrogen here is as an energy store, it being utilized, for example, as a fuel to stabilize the electrical energy supply, especially from renewable sources such as wind power, photovoltaic or the like. Hydrogen, though, can also be used for other processes that require a fuel or a reducing agent. The hydrogen obtained during electrolysis can thus be utilized industrially, for example, or electrical energy can be recovered electrochemically using fuel cells.

The separation of water into its chemical components hydrogen and oxygen (O₂) can thus be carried out by means of suitable electrolysis cells. One particularly important form is the PEM electrolysis described, which proves in particular to be very load-dynamic and better suited for coupling fluctuating power levels in comparison to alkaline electrolysis approaches, owing to less complex peripheral equipment. In particular, high current densities and power levels can be achieved via PEM electrolysis, even with higher load gradients; the high quality or purity of the hydrogen product is advantageously maintained, for example, even in partial load or overload operation.

Hydrogen is already employed in countless applications in industry and technology. The potential to produce H₂ in large quantities in a climate-neutral manner and/or to store or transport it “carbon-free”, for example via hydrogen carriers such as ammonia, continues to show, for example, transport and the chemical and steel industries completely new ways to supply entire sectors with green energy or to operate them in a climate-friendly way. In addition, hydrogen as a fuel or additive for conventional fuels is highly interesting already now, but also in perspective, because of its potential to produce no or fewer emissions.

In a PEM electrolysis cell, a membrane is provided which has a respective catalyst layer on surfaces facing away from each other. The catalyst layers are usually bordered by respective gas diffusion layers, each adjoined in turn by electrically conductive contact plates, occasionally also called bipolar plates, which serve, among other things, for electrical contacting.

Hydrogen is generated electrolytically from water as reactant. This is an electrochemical process in which water is separated into its chemical constituents, oxygen and hydrogen. The electrochemical cell reactions can be described and distinguished as follows:

| | |
|---|---|
| Anode electrode | 2H₂0 → 4H⁺ + 0₂ + 4e⁻ |
| Cathode electrode | 4H⁺ + 4e⁻ → 2H₂ |

In a polymer electrolyte membrane electrolysis, the respective two partial reactions are spatially separated by an ion-conductive membrane, which must be suitably provided with electrodes, in particular a cathodic catalyst and an anodic catalyst. In addition to improvements in materials, significant cost reductions, among other things, can be achieved through improvements in fabrication processes.

Since the production of PEM hydrogen electrolyzers (PEMHE) must increase significantly in throughput and measure (scaling) in order to achieve agreed climate targets, there is a compelling need for techniques that allow the throughput and production capacity of so-called corresponding catalyst-coated membranes or membrane-electrode assemblies to be improved.

In order to protect the electrolysis units from environmental influences, they need an enclosure such as a container. PEM water electrolyzers must additionally operate with demineralized, more particularly high-purity, water. The inside temperature of the container should therefore not normally fall below a temperature of around 5° C. The water-carrying components, which contain water, may otherwise freeze up and paralyze the operation of the entire facility. This would run counter to the purpose of operating (offshore) wind power stations without grid coupling in as low-maintenance and self-sufficient manner as possible.

At an outside temperature of less than 5° C. outside the containment, heat is transported to the outside. At the minimum design temperature in the outside area of minus 20° C., about 1 to 2 kW of heat then dissipate per hour. Heat loss, however, is dependent on factors including the insulation of the container. This heat must be returned to the container to keep the 5° C. reasonably constant.

If, on the other hand, in cold weather no renewable electricity is available (e.g. because there is no wind blowing), the energy must be made otherwise available to enable operation of the facility and the continuous use of renewable wind energy. The water-carrying lines between the containers or containments must also be heated so that they do not run the risk of freezing up. This also requires energy, which must be provided from other sources in the event of a calm in wind.

Some existing solutions include the provision of battery storage devices. The battery storage device provides electrical power to maintain the heater. However, this solution has its drawbacks. For instance, capacity is significantly limited. Realistically, for example, capacities of about 100 to 150 kWh would be required for the present application. So-called battery energy storage systems (BESS) have the disadvantage in particular that they are expensive, large and heavy. Therefore, other, better solutions are urgently needed.

A different but technically obvious solution is a diesel generator. However, this solution has the disadvantage that the diesel fuel needs to be refilled regularly and the basic idea of developing a reasonable CO₂-emission-free offshore technology cannot be realized.

It is therefore an object of the present invention to provide means which allow wind power stations without grid coupling in direct operation with electrolysis facilities, more particularly facilities for water electrolysis, be it “onshore” or “offshore”, to be supplied with energy as simply and reliably as possible, and at the same time to design the operation of the one or more facilities to be as autonomous and low-maintenance as possible.

This object is achieved by means of the subject matter of the independent claims. The dependent claims relate to advantageous configurations.

One aspect of the present invention relates to an energy supply system for coupling to a wind power station used in island mode, i.e. without grid coupling, for example as a decentralized energy facility.

The wind power station (wind turbine) is configured to operate an electrolysis facility or an electrolyzer for the production of green hydrogen with wind energy. The electrolysis facility preferably involves a PEM water electrolysis. Alternatively or additionally, an alkaline electrolysis can be used to produce hydrogen.

The energy supply system has a solar energy source, comprising a (at least one) solar thermal collector and/or a (at least one) photovoltaic module. The solar energy or sun energy source is further configured to supply the electrolysis facility, in particular a containment or enclosure thereof and its water-carrying lines, with 24 thermal energy (auxiliary energy) in the event of the absence of wind energy, i.e. preferably in the event of a calm in wind, no wind energy can be tapped, or of a defect of the facility. This is especially in order to ensure the operation of the facility over the (short-term) “obstacle” mentioned. Designing the solar energy facility as a solar thermal collector can, like a photovoltaic module, correspondingly provide thermal energy indirectly via an electric heater, for example, for grid-independent electrolysis operation.

The outstanding advantage of the inventive solution presented is that solar energy is frequently available as an energy source in the event of lulls in wind and can thus be utilized advantageously. Both photovoltaics and solar thermal energy can be used for the solution. Photovoltaics in particular offers the advantage of being able also to operate an electrical facility control function for both the wind power station and the electrolysis system during the calm in wind. As a result, an existing battery as an intermediate electrical storage device can be made significantly smaller. This means a smaller space requirement, less weight on the platform, and much lower costs.

The present idea of the invention, in particular to provide another renewable energy source, does not appear intuitive with regard to the application of wind power stations, as the wind power station itself offers hardly any usable space, while the production of solar energy offers a great deal.

In one configuration, the photovoltaic module (in addition or alternatively) is set up to supply a control function and/or a water treatment function of the electrolysis facility with electrical energy.

In one configuration, the energy supply system comprises (two or more) photovoltaic modules with a module area of at least 50 m² per electrolysis unit. An electrolysis unit can preferably have or be provided with a containment of at most the size of an ISO container. In this context, for example, at least 50 m² of photovoltaic module area per electrolysis module would be installed per container, more particularly on the container. This configuration is particularly advantageous and balanced with regard to the available solar-active area on the respective container or the platform of the wind power station and also to the demand for solar energy for the grid-autonomous, temporary operation of the wind power station or the electrolyzer in the event of a calm in wind.

In one configuration, the photovoltaic module is configured to be mounted (in an area-optimized manner) on the roof of an electrolysis unit or of a container forming the containment of the unit.

In one configuration, preferably the at least one solar thermal collector, but under certain circumstances the photovoltaic module as well, is configured for installation during operation on the tower of the wind power station. In view of the difficulty described above in operating wind power stations or electrolysis facilities independently and thus in making it possible at all to reasonably utilize renewable energies, this configuration actually offers the synergy of profitably functionalizing the otherwise unutilized area of the wind power station tower for energy supply.

In one configuration, the wind power station is an “offshore” wind power station and the solar thermal collector or photovoltaic module is embodied floating (on the sea) during the operation of the wind power station. Furthermore, of course, the corresponding solar energy sources conveniently are electrically connected, and are coupled or can be coupled, to the electrolysis facility.

In one configuration, the solar thermal collector has a reservoir for a heat transfer medium and is designed in particular as a flat collector or as a vacuum tube collector, wherein a heat-absorbing face of the solar thermal collector transfers heat to the heat transfer medium in the operation of the system (the wind power station). According to this configuration, the required heat can be adjusted gradually and according to demand (temporarily) or in a tailored manner to the corresponding heating required for the independence of the facility, preferably by the holding of the heat transfer medium in the reservoir.

In one configuration, the reservoir is installed under a platform supporting the electrolysis system during operation or in the tower of the wind power station. Advantageously, as described above, unutilized area of the wind power station can be utilized appropriately and according to the invention via this positional relationship.

Another aspect of the present invention relates to a method for supplying a wind power station used in island mode with solar energy, in particular using the energy supply system described. The supply method can therefore advantageously represent a method for operating the energy supply system.

The wind power station supplies wind energy for the operation of the electrolysis facility for the provision of green hydrogen, wherein the solar energy source comprising a solar thermal collector and/or a photovoltaic module is used to supply the electrolysis facility with thermal energy in the event of the absence of wind energy (as described above).

In one configuration of the method, the at least one solar thermal collector and/or the at least one photovoltaic module—of course in each case two or more of the components may also be provided—are used to supply the containment and water-carrying lines of the electrolysis units with thermal energy, in particular to heat them or to keep them at the operating temperature described and thus to protect them from freezing up in an emergency.

In one configuration, the photovoltaic module is additionally used to supply a control function and/or a water treatment function of the electrolysis facility with electrical energy.

In one configuration, the solar thermal collector supplies the electrolysis facility with thermal energy only when no wind energy can be tapped, i.e. wind energy is unavailable due to wind calmness or a facility defect.

In one configuration, the solar thermal collector transfers heat from the heat-absorbing face thereof to the heat transfer medium described, during operation of the facility, wherein this heat is used only if necessary or gradually, for example in phases over night or in the event of a lull in wind, for heating the electrolysis units.

In one configuration, the electrical energy provided by the photovoltaic module is used to operate an air conditioning facility of the wind power station and/or the electrolysis facility. The term “air conditioning facility” is intended presently to be broadly understood and to encompass, among others, heating, ventilation and air conditioning in general.

In one configuration, the electrical energy provided by the photovoltaic module is used to charge a battery storage system (BESS system) or so-called uninterruptible power supply systems of the wind power station as and when required.

Configurations, features and/or advantages which refer presently to the energy supply system refer analogously to supply methods, and vice versa.

The expression “and/or” or “or” used here, when used in a series of two or more elements, means that any of the listed elements can be used alone, or any combination of two or more of the listed elements can be used.

Further details of the invention are described below with reference to the figures.

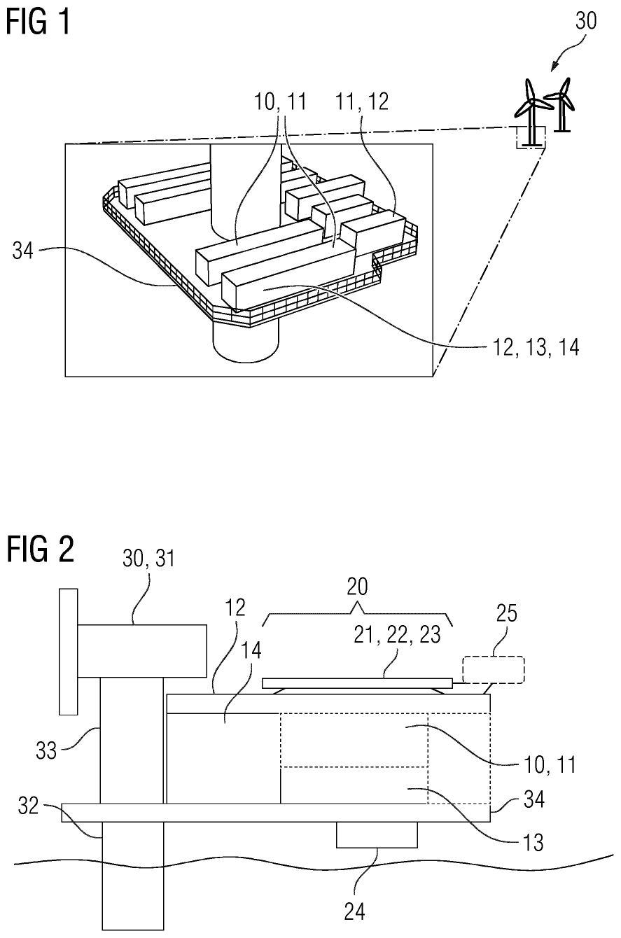

FIG. 1 shows a schematic overview of an offshore wind power station complete with an electrolysis facility which is configured to operate the wind power station for the production of green hydrogen with wind energy.

FIG. 2 shows a schematic side view with details of the energy supply system according to the invention and other components of the wind power station.

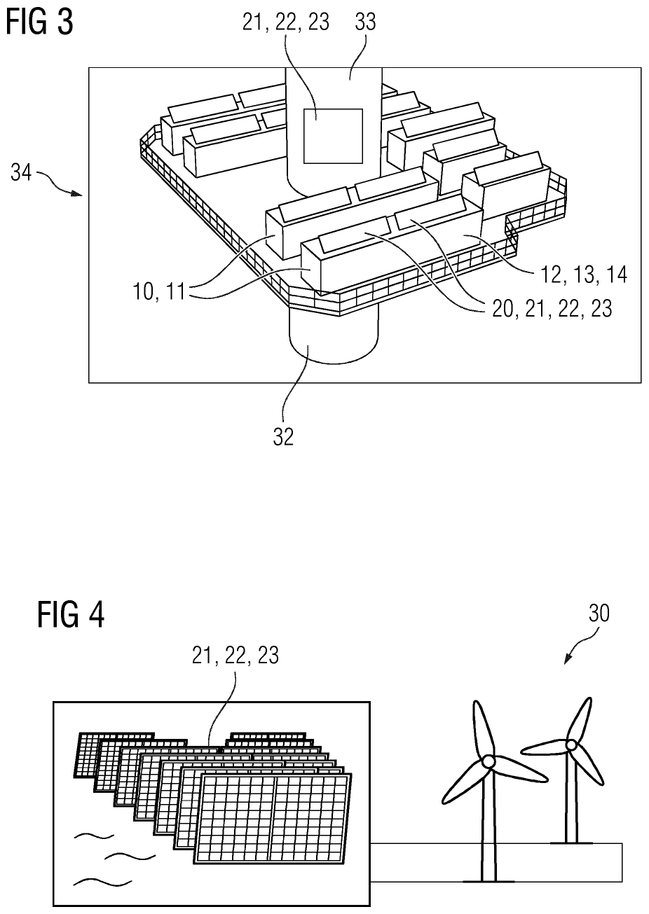

FIG. 3 shows—in a representation analogous to FIG. 1—parts of the energy supply system according to the invention in a perspective view of the platform.

FIG. 4 shows a schematic simplified view of a floating configuration of the solar energy source according to the invention.

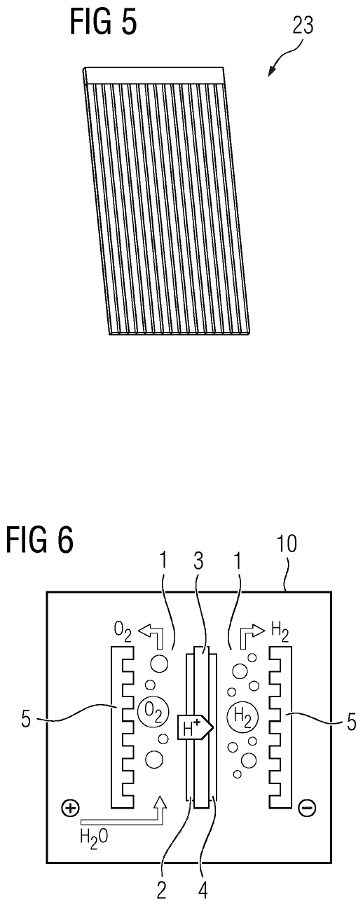

FIG. 5 shows an embodiment of the solar energy source according to the invention as a solar thermal collector.

FIG. 6, finally, indicates the functioning of the water electrolysis using a schematic.

In the working examples and figures, elements that are the same or have the same effect may each be provided with the same reference signs. The elements shown and their proportions to one another should fundamentally not be considered to be true to scale; instead, individual elements can be shown in exaggerated thickness or with large dimensions for better presentability and/or for better understanding.

FIG. 1 shows a wind power station 30 in the upper right part. In the lower region of the tower (cf. reference numeral 33 below), above the sea level, a platform 34 is provided thereon and is shown in more detail in the rest of the illustration.

The platform carries in particular containers 12, which comprise electrolysis elements, i.e., for example, individual electrolyzers, or electrolysis facilities 11. Parts of these containers 12 may also comprise control elements or “balance-of-plant” elements 14, which includes, for example, all components of the electrolysis units, except for the individual electrolysis cells 11 themselves. Additional components or facility parts accommodated in the containers may also involve holding tanks for the reactant water of the electrolyzers 11, or the like.

The wind power station 30 preferably has no grid connection or grid coupling in the present case, but with the wind energy absorbed directly operates the electrolysis facility 11 described, for the production of preferably green hydrogen. More details on the reactions concerned and the functioning of the water electrolysis are described below with reference to FIG. 6.

The wind power station 30 is preferably an offshore wind power station. Deviating from the illustrations of FIGS. 1 and 3, however, the means presented in accordance with the invention for the improved supply of energy to the facility are readily applicable to “onshore” facilities as well.

The strategy of providing the electrolysis facility 11 via individual containers 12, preferably ISO containers, advantageously ensures a simple maintenance and repair process, and protects the facility components simultaneously against climatic and weather influences and also from corrosion and faulty mechanical influences.

FIG. 2 shows in a simplified alternative (schematic) view the wind power station 30 described, which is also equipped with an energy supply system 20 of the invention (see on the right in the image). Rotor blades (not explicitly marked) of the turbine 30 are indicated in the left-hand area of the diagram, and directly adjacent thereto a nacelle 31 or the generator part of the facility.

The platform 34 described above on the tower 33 is arranged above a base indicated by the reference numeral 32. Although the sea level is intended to be indicated by the wave contour, the present invention is equally applicable correspondingly to wind power stations installed on land without grid coupling.

The platform 34 carries in particular the electrolysis facility 11, comprising usually a plurality of “electrolysis stacks”. Each of the stacks in turn preferably has a plurality of electrolysis cells 11 (cf. FIG. 6 below), which are grouped together in succession to form the stacks and connected accordingly.

Containment of the electrolysis facility parts by the container 12 is important for functions including the necessary “air conditioning” of the electrolysis facility 11.

The purpose of directly connected electrolysis systems in renewable energy facilities, such as wind power stations, is that of operation in as low-maintenance and autonomous a manner as possible over a long period of time. The costs of maintenance and replacement of components, especially on the open sea, are very expensive and cost-intensive. In the future, such energy facilities, and thus such electrolysis facilities, will have to manage significantly without grid connection in order to avoid corresponding transformation or line losses. Nevertheless, the hydrogen or comparable energy source can be produced efficiently at the site of the energy facility and for example can be stored as an energy store itself or indirectly via an energy carrier or, alternatively, can be fed into pipelines.

This advantage is accompanied by the difficulty of not having grid energy available for auxiliary systems and for heating or maintaining the operating temperature of the wind power station and electrolysis facility.

A region of the container indicated with the reference numeral 14 stands, for example, for balance-of-plant components and/or a control function for the electrolyzers, transformers, rectifiers or else a battery “back-up” or BESS battery system-advantageously small in sizing by virtue of the present invention.

In contrast, the region 13 may denote a water treatment function for the reactant water, in particular comprising a seawater desalination plant (corresponding water-carrying lines are not explicitly drawn in the figures presently, but extend usefully from a holding tank to each of the electrolysis units shown, in order to supply the units accordingly with reactant water.

Above, preferably on the roof of container 12, a part of the energy supply system 20 according to the invention is installed. The system 20 comprises a solar energy source 21, comprising a photovoltaic module 22 and/or a solar thermal collector 23. The solar energy source 21 is also configured to supply the electrolysis facility 11, in 16 particular the containment 12 and water-carrying lines, with thermal energy in the event of the absence of wind energy.

A configuration of the solar energy source as a photovoltaic module 22 can additionally be used to supply a control function 14 and/or a water treatment function 13 of the electrolysis facility with electrical energy.

In addition, water treatment/water purification or desalination 13 may require thermal energy, thus heat, which may come from the collectors.

In contrast, a configuration of the solar energy source as a solar thermal collector 23 is preferably used according to the invention in such a way that the electrolysis facility 11 is supplied with thermal energy only when no wind energy can be tapped. This may be the case, for example, in the event of a defect, an emergency stop of the wind generator or simply in the event of a calm in wind.

The electrical energy provided by the photovoltaic module can also be used to operate an air conditioning system of the wind power station 30 and/or of the electrolysis facility 11.

Finally, the electrical energy provided via the photovoltaic module 22 can be used alternatively or additionally to charge a battery storage device (not explicitly marked) of the wind power station 30 (only) as and when necessary.

The reference numeral 24 indicates, by way of example and schematically, a reservoir for a heat transfer medium. The reservoir 24 may further be part of the energy supply system 20 and is therefore conveniently coupled functionally to the corresponding solar thermal collector.

Accordingly, the solar thermal collector 23 can transfer heat from a heat-absorbing surface thereof to a heat transfer medium (also not explicitly marked in the present case) during operation, in one configuration of the energy supply method that is in accordance with the invention. As and when necessary, this heat can then be used gradually to heat the electrolysis units.

In FIG. 2, a heat pump or an electric heater 25 is further indicated schematically in dashed form (optional), which can be provided in order to make use of any electrical energy obtained via photovoltaics (PV) for thermal use for heating purposes.

FIG. 3 shows the platform 34 of a wind power station 30 described herein, which is equipped with the energy supply system 20 according to the invention; similar to the illustration in FIG. 1. It can be seen that each roof of the containers 12 shown is provided with a solar energy source, whether as a photovoltaic module 22 or as a solar thermal collector 23.

Preferably, the energy supply system 20 comprises photovoltaic modules 22 with a module area of at least 50 m² per electrolysis unit. The stated module area does not have to be present for each container, but instead of course the available solar-active roof area of those containers which only contain “balance-of-plant” components or auxiliary systems can also be equipped with photovoltaic modules.

Furthermore, approximately or at least three electrolysis units per platform 34 or facility 10 may be present. However, the electrical power of an electrolysis unit that is to be taken up may be around 4 to 5 MW.

Alternatively or in addition, a photovoltaic module or else a solar thermal collector can be mounted on the tower 33 of the wind power station.

In other words, summing up and possibly containing other features applicable to all configurations of the present invention, the present invention can be described in the following words.

Solar energy is used at the wind power station by using photovoltaic modules or solar thermal collectors to protect the electrolysis facility from freezing in the event of cold outside temperatures and a lull in wind. The advantage of this is that very often no clouds cover the sky in wind-calm conditions and thus direct sunlight can be used during the day.

In principle, all solar cell technologies are suitable for the use of photovoltaics. Thick-film cells made of monocrystalline (c-Si) or polycrystalline silicon have probably the highest efficiency so far and therefore require the smallest footprint for the electrical power required. These modules can be used to generate about 200 W/m² under direct sunlight. Thus, the module area described above (40 to 50 m²) would already be sufficient for a minimum supply of the electrolysis containers.

As described, the photovoltaic modules 22 can be placed, for example, on the roof of the electrolysis containers 12 and can provide electrical power in any case in the absence of wind. This electrical power can be used directly for the measurement and control equipment or the HVAC air conditioning system of the electrolysis units at standstill. In addition, a back-up battery can also be charged to provide electrical power (only) at night, for example.

But it can also be used for thin-film solar cells such as amorphous (a-Si), microcrystalline (μm-Si) silicon, CIS/CIGS (copper-indium(-gallium-)-(di) selenide, CdTe (cadmium-telluride) or organic solar cells. Modules made of these technologies can be applied, for example, to flexible films and can thus be attached to the round tower of the wind power station 30.

In addition, perovskite solar cells can also be used. These thin-film technologies are able to convert even diffuse light very well and thus to make the (non-sun-facing) back of the tower usable as well.

In addition, the use of concentrated photovoltaics (CPV) is conceivable. However, since these modules require direct sunlight and thus have to be made to track the course of the sun, such an installation appears more complex.

The electrical energy of the installed photovoltaic modules does not have to be used only at low temperatures and on lulls in wind, but can instead also be used to supply the electrolysis unit the entire time.

In addition to the use of photovoltaic modules, solar thermal collectors can also be installed for hot water production (see above). The heat medium with the heat collected can be stored temporarily in tanks. These tanks can be placed, for example, under the platform or in the wind power station tower. This heat can then be used gradually, e.g. to bridge the night.

FIG. 4 also indicates a further configuration and installation of the photovoltaic modules (or the solar thermal collectors) based on a schematic view. It can be recognized that in the case of offshore platforms—in addition to a placement of the solar modules on the electrolysis platform or directly on the wind power station tower—it is also possible in accordance with the invention to provide solar modules floating on the sea, which are located near to the tower 34. In the case of so-called onshore platforms, these could be supported on land or installed on the ground instead. The electricity generated there can then be directed to the platform accordingly and used for the purposes described.

FIG. 5 indicates an illustrative specific configuration of a solar thermal collector. For example, both flat collectors and vacuum tube collectors are suitable for use as solar thermal collectors. In both technologies, solar radiation heats up a heat-absorbing surface, which transfers the heat to the heat transfer medium. The hot water generated in this way can be used to heat up the inside of the containers and to protect them from freezing as described.

FIG. 6 shows an electrolysis cell 10, in particular a PEM electrolysis cell for water electrolysis. The core of such a polymer electrolyte membrane electrolysis cell 10 is usually formed by a membrane-electrode assembly (MEA), which is indicated in the middle. The MEA has a membrane 3 coated with catalysts.

A first catalyst material is identified with the reference numeral 2. Conversely, a second catalyst material, different from the first catalyst material, is drawn with the reference numeral 4. In the region of the layer formed by the respective catalyst material, the respective cell reaction of the electrolysis takes place. During operation as intended, electrons are taken off via the respective catalyst material and a gas diffusion layer to the contact or bipolar plates 5. For this reason, a high electrical conductivity of the catalyst layers is also desired.

It is also recognizable that reactant water (H₂O) is commonly provided on the anode side, and which by means of the electrolysis process can be released and obtained as oxygen (O₂) at the anode and hydrogen (H₂) at the cathode.

The membrane 3 or a starting material which is usually to be coated with the “catalyst” for the coating of the membrane 1 usually contains a perfluorosulfonic acid material (PFSA), polymer or ionomer 2.

As an alternative to the present configuration of a PEM water electrolysis, a different electrolysis variant, for example an alkaline water electrolysis, can also be used in the context of the invention, without limiting the generality.

1-15. (canceled)

16. An energy supply system for coupling to a wind power station used in island mode, wherein the wind power station is configured to operate a polymer-electrolyte-membrane (PEM) electrolysis facility for producing green hydrogen with wind energy, the electrolysis facility having electrolysis units with a containment and water-carrying lines, the energy supply system comprising:
a solar energy source, having at least one of a photovoltaic module or a solar thermal collector, configured to supply the containment and water-carrying lines of the electrolysis units of the electrolysis facility with thermal energy when wind energy is not available.

17. The system according to claim 16, wherein the photovoltaic module is configured to supply at least one of a control function or a water treatment function of the electrolysis facility with electrical energy.

18. The system according to claim 16, which comprises photovoltaic modules having a module area of at least 50 m² per electrolysis unit.

19. The system according to claim 18, wherein said photovoltaic modules is configured for mounting on a roof of a respective electrolysis unit.

20. The system according to claim 18, wherein a respective said photovoltaic module is configured for installation during operation on a tower of the wind power station.

21. The system according to claim 16, wherein the wind power station is an offshore wind power station and wherein at least one of said photovoltaic module or said solar thermal collector, during an operation of the wind power station, is configured to float on water and is coupled to the electrolysis facility.

22. The system according to claim 16, wherein said solar thermal collector comprises a reservoir for a heat transfer medium and is formed as a flat collector or as a vacuum tube collector, and wherein a heat-absorbing face of said solar thermal collector is configured to transfer heat to the heat transfer medium in an operation of the system.

23. The system according to claim 22, wherein said reservoir is installed under a platform supporting the electrolysis facility or in a tower of the wind power station.

24. A method of supplying solar energy, the method comprising:
operating a wind power station in island mode and thereby providing wind energy to operate an electrolysis facility for producing green hydrogen; and
providing a solar energy source, having at least one of a photovoltaic module or a solar thermal collector, for supplying the electrolysis facility and/or the wind power station with thermal energy when the wind energy is absent.

25. The method according to claim 24, which comprises providing the energy supply system according to claim 16 and coupling the system to the electrolysis facility.

26. The method according to claim 24, which comprises using the photovoltaic module and/or the solar thermal collector to supply a containment and water-carrying lines of the electrolysis units of the electrolysis facility with thermal energy.

27. The method according to claim 24, which further comprises additionally using the photovoltaic module to supply at least one of a control function or a water treatment function of the electrolysis facility with electrical energy.

28. The method according to claim 24, which comprises supplying the electrolysis facility with thermal energy from the solar thermal collector only when no wind energy can be tapped.

29. The method according to claim 24, wherein the solar thermal collector transfers heat from a heat-absorbing face thereof to a heat transfer medium during operation, and wherein the heat, as and when necessary, is used gradually for heating the electrolysis units.

30. The method according to claim 24, which comprises using the electrical energy provided by the photovoltaic module to operate an air conditioning facility of at least one of the wind power station or the electrolysis facility.

31. The method according to claim 24, which comprises using the electrical energy provided by the photovoltaic module to charge a battery storage device of the wind power station as and when necessary.
